(19) United States
(12) Patent Application Publication
(10) Pub. No.: US 2012/0011007 A1
(43) Pub. Date: Jan. 12, 2012

(54) Mobile Payment Using DTMF Signaling

(75) Inventors: Charles Douglas Blewett, Madison, NJ (US); Megan Blewett, Cambridge, MA (US); Juan A. Garay, Gutenberg, NJ (US); Vincent C. Grosso, New York, NY (US); Robert C. Haarde, Sudbury, MA (US); Thomas Killian, Westfield, NJ (US); Simon Urbanek, Madison, NJ (US); Eric Cheung, New York, NY (US)

(73) Assignee: AT&T INTELLECTUAL PROPERTY I, L.P., Reno, NV (US)

(21) Appl. No.: 12/831,951

(22) Filed: Jul. 7, 2010

(51) Int. Cl. G06Q 20/00; G10L 17/00; H04L 12/56; G06F 17/30

(52) U.S. Cl. 705/16; 707/769; 704/246; 370/389; 707/E17.014

(57) ABSTRACT

Systems and methods are disclosed for mobile payment using dual-tone multi-frequency (DTMF) signals. A mobile device equipped with at least a speaker and an input is used to connect to a server on the mobile network. Upon authentication of a user of the mobile device, the server generates the payment key, translates the key to DTMF signals, and plays the DTMF signals over the speaker of the mobile device. The user holds the mobile device speaker close to a microphone of a DTMF scanner at a POS terminal. The DTMF scanner includes logic that extracts the payment key from the DTMF signals, and the POS terminal uses the payment key to bill the user. The POS terminal transmits the bill with the payment key to the server on the network. The server ensures that the key is active, and debits an account for the user based on the amount presented in the bill. The key is de-activated after a specified time period or one use, whichever occurs first.

### BACKGROUND OF THE INVENTION

1. Field of the Invention

The present invention relates to mobile devices. In particular, the present invention relates to authenticating and making payments at a point-of-sale (POS) using a mobile device.

2. Background of the Invention

There are estimated to be 3.3 billion active cellular telephones in use across the world today. The average cost of these telephones is $25. Obviously, the majority of these phones have limited functionality. Although most modern telephones in developed countries have functionality similar to that of personal computers, the majority of phones in use today are simple devices having only the ability to send and receive telephone calls, especially for those phones found in developing countries.

This is not to say that users of such phones do not have a need for advanced features. Regardless of country of residence, social standing, income level, etc., the information revolution is taking over, and certain needs are universal. For instance, transmitting identity information is a universal need having different approaches. Purchasing goods and services at a point of sale (POS) is another universal need. Especially prevalent in many societies is the ability to make payments without using cash. Credit cards are a prime example of such payment methods, however, credit cards can be lost, stolen, and can be forgotten.

Mobile payment is becoming popular in developed nations. Mobile payment typically includes a near-field communication (NFC) system, whereby an NFC-equipped phone is waved in front of an NFC scanner, such as an RFID scanner, and an amount is debited from the NFC circuitry or secure element embedded within the phone. However, this requires NFC-equipped phones, which leads to added costs to modify phones and POS terminals. Further, the information stored on the phone itself leads to insecurity. Sensitive information can be stolen from the phone, or the phone itself can be stolen and/or hacked.

What is therefore needed is a system and a method for enabling mobile payments using simple mobile devices equipped with at least a speaker and an input.

### SUMMARY OF THE INVENTION

The present invention solves the above problems by using dual-tone multi-frequency (DTMF) signaling to transmit a unique payment key to enable a transaction at a POS terminal. A mobile device equipped with at least a speaker and an input, for instance, a keypad is used to dial a server on the mobile network. A user is asked to authenticate themselves by providing a unique identifier via an input on the device such as a keypad and/or a microphone. Upon authentication of the user, the server generates the payment key, translates the key to DTMF signals, and plays the DTMF signals over the speaker of the mobile device. The user holds the speaker close to a microphone of a DTMF scanner at the POS terminal. The DTMF scanner includes logic that extracts the payment key from the DTMF signals, and the POS terminal uses the payment key to bill the user. The POS terminal transmits the bill with the payment key to the server on the network. The server ensures that the key is active, and debits an account for the user based on the amount presented in the bill.

Advantageously, using DTMF signals allows every mobile device to be used as a payment device, not just smart-phones or NFC-equipped phones. Advantageously, the key is de-activated after a specified time period or after one use, thereby ensuring that any eavesdroppers will not be able to conduct transactions using the key. Besides simply identifying a user, the key may be a credit card number, bank account and routing numbers, or a temporary key that is tied to a particular credit card or bank account. Advantageously, the DTMF scanner can be inexpensively incorporated into existing POS terminals as added hardware, software, or any combination of the two. This system could also be used to transmit the unique key from a consumers mobile device to a telephone coupled to a POS terminal. Advantageously, a user can program a maximum amount per transaction to prevent abuse by an operator of the POS terminal or other entities. Advantageously, a user can enable an authorization method, whereby the server on the network transmits an authorization request of the amount to the user before the user is billed. The authorization request can be triggered by transactions exceeding a predetermined amount adjustable by the user.

In one exemplary embodiment, the present invention is a system for making a payment using a mobile device, including a mobile device with a speaker, an input, and a transceiver for communicating across a network, a point-of-sale (POS) terminal including a microphone for receiving a payment key from the speaker of the mobile device and a transceiver for communicating across the network, and a server on the network including authentication logic for authenticating a user of the mobile device, key generation logic for generating the payment key in response to a request from the mobile device, and charging logic for charging a user account upon receipt of a bill from the POS terminal, the bill including the payment key received by the microphone and an amount to be charged to the user account. The payment key comprises dual-tone multi-frequency (DTMF) signals transmitted from the server to the POS terminal via the speaker on the mobile device. The authentication logic authenticates the user by comparing a unique identifier of the user with an authentication database. The unique identifier may include one or more of a username, a password, hardware identifiers in the mobile device, accessory cards, and/or biometric identifiers. A DTMF scanner coupled to the POS terminal can include both the microphone and a DTMF processing logic. Authorization logic on the server transmits an authorization request to the mobile device to confirm an amount larger than a predetermined amount.

In another exemplary embodiment, the present invention is a method for making a payment using a mobile device, including receiving a key request from a mobile device authenticating a user of the mobile device, generating a payment key, transmitting the payment key to the mobile device using dual-tone multi-frequency signals, receiving from a point-of-sale (POS) terminal a bill, the bill including the payment key and an amount to be charged, determining that the received key is valid, and debiting the amount to be charged from a user account associated with the user. Authenticating the user further comprises comparing a unique identifier received from the mobile device with an authentication database. The unique identifier is one or more of a username, a password, hardware keys, and/or biometric identifiers. The method further includes verifying that the amount to be charged does not exceed a predetermined amount by transmitting an authorization request to the mobile device, and receiving an authorization via the mobile device. The payment key can be invalidated after a time period.

In yet another exemplary embodiment, the present invention is a method for charging a user at a point-of-sale (POS) terminal including receiving a plurality of dual-tone multi-frequency (DTMF) signals from a speaker on a mobile device, extracting a payment key from the DTMF signals, generating a bill including the payment key and an amount to be charged, transmitting the bill to a server across a network, and receiving a confirmation from the network that the user is billed. Transmitting the bill to the server can occur via a packet-switched network. Receiving the plurality of DTMF tones may occur via a microphone coupled to a telephone and transmitting the bill further occurs via a public switched telephone network (PSTN).

### BRIEF DESCRIPTION OF THE DRAWINGS

FIG. 1 shows a system for making mobile payments using DTMF signals, according to an exemplary embodiment of the present invention.

FIGS. 2A and 2B show a mobile device for making mobile payments, according to an exemplary embodiment of the present invention.

FIG. 3 shows a server for processing mobile payments, according to an exemplary embodiment of the present invention.

FIG. 4 shows a method for processing mobile payments at a server, according to an exemplary embodiment of the present invention.

FIG. 5 shows a method for making mobile payments at a mobile device, according to an exemplary embodiment of the present invention.

FIG. 6 shows a method for processing mobile payments at a POS terminal, according to an exemplary embodiment of the present invention.

FIG. 7 shows a system for making mobile payments at a POS terminal using a PSTN network, according to an exemplary embodiment of the present invention.

FIG. 8 shows a POS terminal having DTMF signal processing logic, according to an exemplary embodiment of the present invention.

FIG. 9 shows a screenshot of a POS terminal submitting a bill, according to an exemplary embodiment of the present invention.

### DETAILED DESCRIPTION OF THE INVENTION

The present invention presents a novel technique for mobile payment. Dual-tone multi-frequency (DTMF) signals transmit a unique payment key to enable a transaction at a POS terminal. A mobile device equipped with at least a speaker and an input is used to connect to a server on the mobile network. Upon authentication of a user of the mobile device, the server generates the payment key, translates the key to DTMF signals, and plays the DTMF signals over the speaker of the mobile device. The user holds the mobile device speaker close to a microphone of a DTMF scanner at the POS terminal. The DTMF scanner includes logic that extracts the payment key from the DTMF signals, and the POS terminal uses the payment key to bill the user. The POS terminal transmits the bill with the payment key to the server on the network. The server ensures that the key is active, de-activates the key from further use, and debits an account for the user based on the amount presented in the bill. The key is further de-activated after a specified time period, thereby ensuring that any eavesdroppers will not be able to conduct transaction using the key. The DTMF scanner can be incorporated into existing POS terminals as added hardware, software, or combinations thereof. A user can program a maximum amount per transaction to prevent abuse by an operator of the POS terminal or other entities. Further, a user can enable an authorization method, whereby the server on the network transmits an authorization request of the amount to the user before the user is billed. The authorization request can be triggered by transactions exceeding a predetermined amount adjustable by the user.

As used herein and throughout this disclosure, the term “mobile device” refers to any electronic device capable of communicating across a mobile network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user's usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

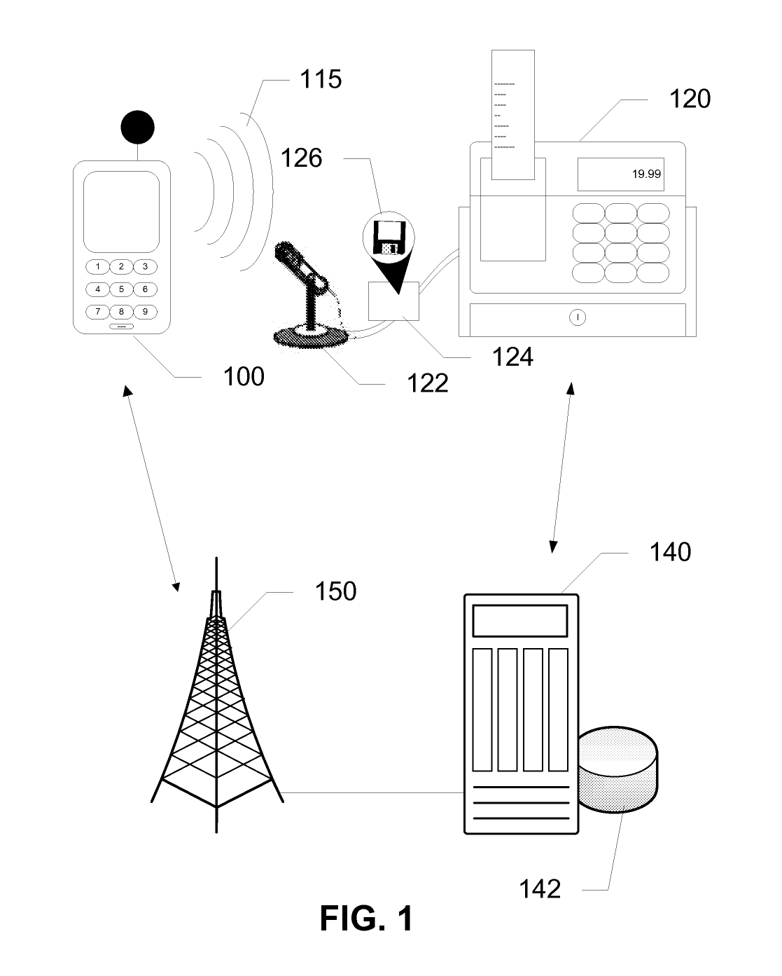

FIG. 1 shows a system for making mobile payments, according to an exemplary embodiment of the present invention. According to this embodiment, the system includes a mobile device 100, a point-of-sale (POS) terminal 120, and a server 140. Mobile device 100 includes at least a speaker to play DTMF tones 115 to POS terminal 120 and a transceiver to communicate with server 140 through a base station 150. POS terminal 120 includes a DTMF scanner including a microphone 122, a DTMF decoder 124, and DTMF logic 126 on DTMF decoder 124. POS terminal 120 further includes a transceiver enabling communication with server 140 across a network. Server 140 includes or is in communication with database 142 storing a user account for a user of mobile device 100.

To make a mobile payment, a user of mobile device 100 requests a payment key from server 140. The request is initiated for instance by making a telephone call across the network to server 140, and interacting with an Interactive Voice Response (IVR) system on server 140. Server 140 authenticates the user of mobile device 100. Server 140 compares an authentication from the user with authentication information stored on database 142. The authentication information may be a username and password, a biometric of the user, etc. When authenticated, the user requests a payment key from server 140 by, for instance, pressing a key on a keypad of mobile device 100, or using a voice command. Server 140 generates a payment key associated with the user and with mobile device 100 and transmits the payment key to mobile device 100 in the form of a plurality of DTMF tones 115. The payment key is a one-time key, and is valid for one purchase or a prescribed time period, whichever occurs first, determined by a service provider or by the user. Mobile device 100 emits DTMF tones 115 via its speaker. When placed next to microphone 122, DTMF tones 115 are received by microphone 122 of POS terminal 120. DTMF decoder 124, using DTMF logic 126, decodes DTMF tones 115 and delivers the payment key to POS terminal 120. POS terminal 120 combines the payment key with a total amount for the user's purchase into a bill, and transmits the bill to server 140. Server 140 receives the bill and extracts the payment key received with the bill to determine the user account that is to be charged. Logic within server 140 further ensures that the payment key is still valid before fulfilling the transaction. If the payment key is valid and if the user account on database 142 has sufficient funds, server 140 accepts the transaction, debits the account of the user, and transmits a purchase confirmation to POS terminal 120. If the payment key is expired, or if there are insufficient funds, server 140 returns an error message to POS terminal 120. Server 140 may debit the amount available in the user's account and prompt POS terminal 120 to request a different payment method for the remainder of the total amount of the bill.

Communication between mobile device 100 and server 140 is shown to occur via cellular base station 150, but can occur via a packet based network, femtocell, or an equivalent means. Similarly, communication between POS terminal 120 and server 140 can occur via a cellular network, PSTN network using phone lines, or packet-based network such as the internet. Preferably, server 140 is at a back end of a service provider's network, and is accessible via several network elements that are not shown, such as gateways, proxies, etc. Server 140 can further be in communication with a billing server, while the user account on database 142 can be stored within server 140 or on the billing server in communication with server 140. The user account can be on database 142 or split among several databases distributed at different servers across the network. DTMF decoder 124 is a separate entity that couples with POS terminal 120 via a USB or equivalent interface. Alternatively, DTMF decoder 124 is incorporated either within microphone 122, or within POS terminal 120. DTMF decoder/POS terminal can further incorporate an indicator such as an LED light that shows a successful receipt of a correctly formatted DTMF signal. This formatting may be in the form of cyclical redundancy checking (CRC) or other internal verification techniques. Other embodiments shown include DTMF logic 126 being incorporated within a POS terminal 120.

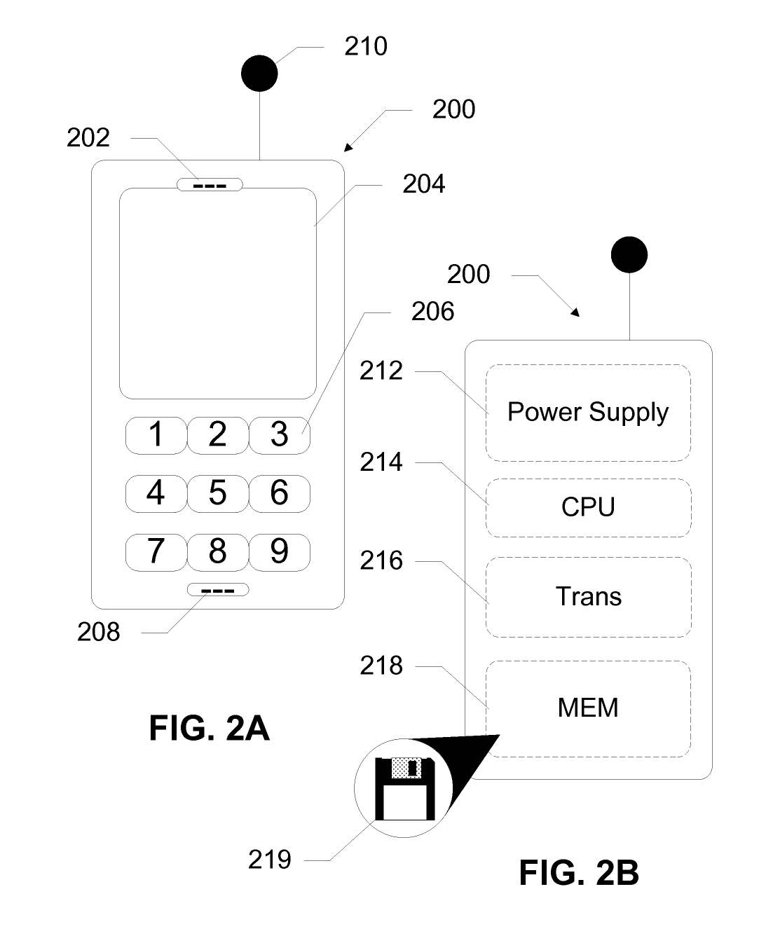

FIGS. 2A and 2B respectively show the exterior and interior components of a mobile device 200, according to an exemplary embodiment of the present invention. According to this embodiment, mobile device 200 includes a speaker 202, a display 204, a keypad 206, a microphone 208, and an antenna 210 (network interface). Mobile device 200 further includes a power supply 212, a central processing unit (CPU) 214, a transceiver 216, and a memory 218. Memory 218 stores logic 219 for operating the components of mobile device 200.

Speaker 202 provides an output for mobile device 200. Speaker 202 can play transmissions, for instance DTMF tones, from a wireless network at a volume that is receivable by a POS terminal. Speaker 202 can be a combination of a small speaker for holding phone conversations, and a larger speaker for projecting DTMF tones to a DTMF scanner. Display 204 is an LCD or LED or other type of display on which a user can view selections, numbers, letters, etc. Display 204 can also be a touchscreen, thereby being used as an input device. Keypad 206 is typically used as an input device, for instance, to type a phone number or a message. Keypad 206 may be a numerical keypad, a QWERTY keyboard, etc. Keypad 206 enables a user to transmit DTMF tones across a network to request a payment key, input a password, etc. The keypad may be implemented as touch sensitive areas on the display. Microphone 208 allows the user to verbally communicate with others using mobile device 200. Microphone 208 may further be used to transmit voice commands to an IVR system on the network, for instance, to request a payment key, provide a biometric input, etc. The microphone may also be used for biometric authentication of the user. Antenna 210 is a transducer designed to transmit or receive electromagnetic waves to and from a network. In conjunction with antenna 210, transceiver 216 allows mobile device 200 to wirelessly communicate with a network, or with other wireless devices. Transceiver 216 may communicate using cellular radio frequencies (RF), WiFi, BLUETOOTH, infrared signals, etc. Power supply 212 provides power to each of the components of mobile device 200, and can include a battery, as well as an interface to an external power supply. CPU 214 controls components of mobile device 200 according to instructions in logic 219 stored on memory 218. Memory 218 comprises any computer readable medium, such as RAM, ROM, etc. Logic 219, at its minimum, enables operation of the components of mobile device 200 and to provide a user interface displayed on screen 204. Logic 219 can further include an application to request payment keys from and provide credentials to a server on the network, in addition to the DTMF and voice commands disclosed above.

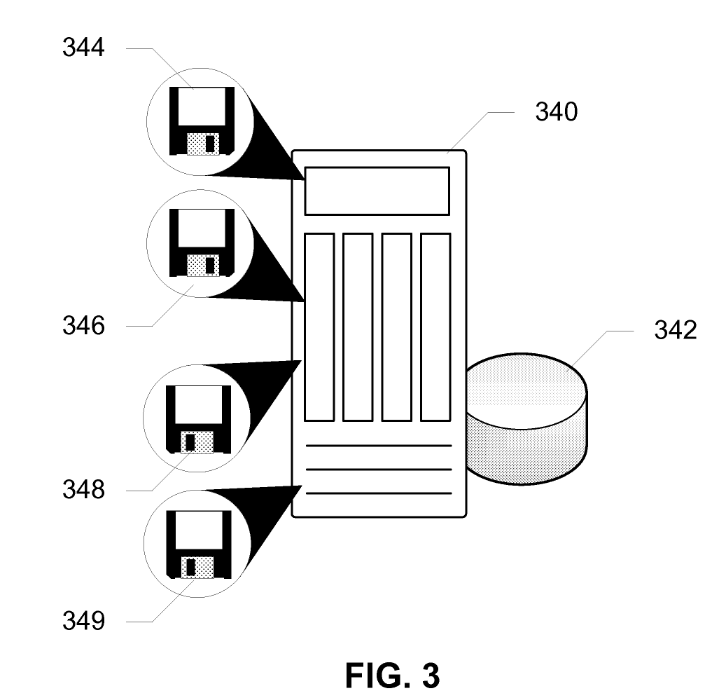

FIG. 3 shows a server 340 for enabling mobile payments, according to an exemplary embodiment of the present invention. Server 340 includes authentication logic 344, key generation logic 346, authorization logic 348, and charging logic 349 stored on a memory server 340. Server 340 enables mobile payments by transmitting unique payment keys to users' mobile devices in the form of DTMF tones. When the user of the mobile device desires to make a payment at a POS terminal, the user requests the payment key from server 340. Authentication logic 344 authenticates the identity of the user. This may be accomplished by prompting the user for one or more unique identifiers, such as a username, password, biometric identifier, etc. Authentication logic 344 compares the received identifier with a stored identifier in database 342. Database 342 can include a user account as well. When the user has been authenticated, key generation logic 346 generates a unique one-time temporary payment key and converts the payment key to DTMF tones. Key generation logic 346 may include a random number generator or other algorithm. The payment key further has an expiration time determined by a service provider or the user. The payment key is transmitted to the mobile device of the user over the mobile network in the form of DTMF tones. The payment key is never stored on the mobile device, it is simply transmitted to a speaker of the mobile device.

Upon scanning and processing the DTMF signals, the POS terminal generates a bill containing the payment key and an amount to be charged, and transmits the bill to server 340. Authorization logic 348 processes the payment key received in the bill to determine the originating mobile device and corresponding user account. If the payment key is valid, charging logic 349 debits the user's account by the amount in the bill. If the amount is above a defined threshold, authorization logic 348 may further prompt the user of the mobile device to confirm or authorize the charge. This is performed by transmitting an authorization request to the mobile device associated with the payment key. A user of the mobile device responds to the request. The response can include a passcode, biometric identifier, or simply a confirmation that the amount is correct. If the account of the user does not contain sufficient funds, charging logic 349 may debit the account the available amount or may refuse the transaction. The POS terminal is notified in either case of a remaining amount the user must pay.

The logic units described above may all be stored on server 340, or stored across multiple servers on a back end of the service provider's network. For instance, charging logic is stored on a billing server in communication with server 340. For instance, authorization logic 348 and authentication logic 344 are stored on different servers at different logical points on the network. For instance, key generation logic 346 is stored on a key generation server. Multiple instances of the aforementioned logic units can be operated at different logical points on the network for the sake of redundancy and network efficiency.

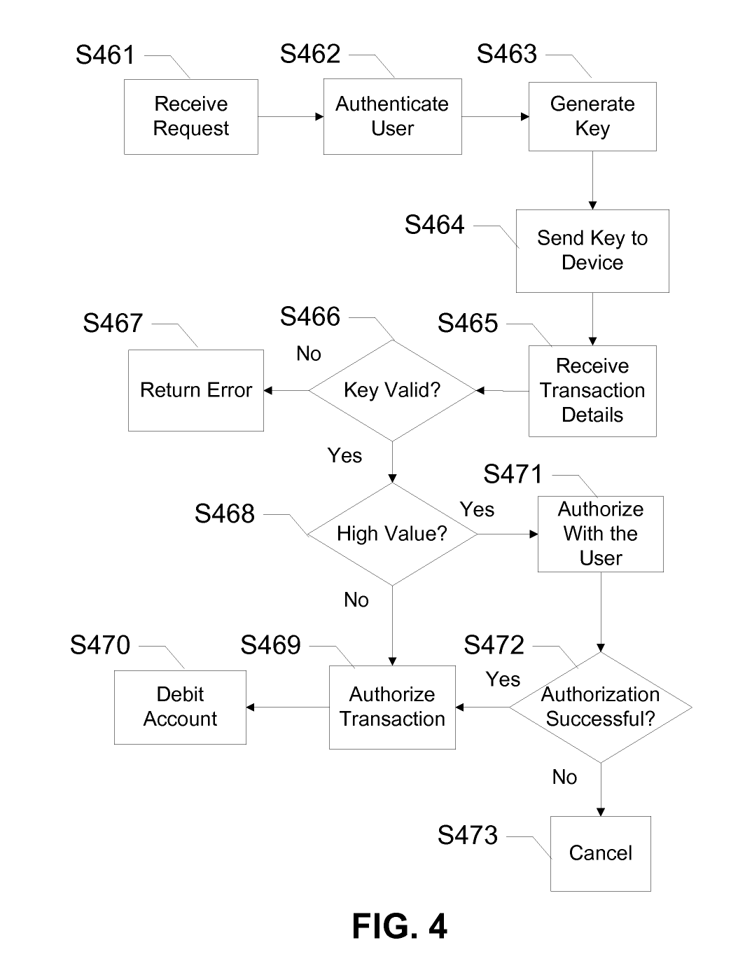

FIG. 4 shows a method for processing mobile payments at a server, according to an exemplary embodiment of the present invention. The method begins with a request for a payment key S461 received at the server on the network. The request is received from a mobile device dialing into the server and navigating a menu tree, for instance, an IVR system stored on the server. A user of the mobile device is authenticated S462 using one or more of several methods, including a username/password combination, a biometric identifier such as voice recognition, etc. The voice recognition can prompt the user to speak a random string of words every time, to prevent fraudulent transactions by unauthorized users who have recorded the user's voice. The authentication is verified by comparing with a database of known unique identifiers for the user. Upon a successful authentication, a payment key is generated S463. The payment key is a unique string of alphanumeric or similar characters, and can be represented by a plurality (or sequence) of DTMF tones. The payment key is valid for only one transaction or a short period of time sufficient to complete a transaction at a POS terminal, whichever occurs first. If a transaction is unsuccessful, a user can request a new payment key, at which point the previous payment key is rendered invalid.

The payment key is transmitted to the mobile device S464 via a plurality of DTMF tones that are played over a speaker of the mobile device. Notably, the mobile device never stores the payment key—the playback of the DTMF tones on the speaker occurs in real-time as the DTMF tones are transmitted from the server. The mobile device simply acts as a conduit for the playback of the DTMF tones from the server to the microphone at the POS terminal. The POS terminal includes a DTMF decoding logic that extracts the payment key from the received DTMF signals, and generates a bill including the payment key and an amount to be charged to the user for the purchase, etc. that the user has made. The bill is received S465 by the server. The server determines if the key is valid S466, i.e. that the key is not expired or previously used. If the key is invalid, an error message is returned S467. If the key is valid, then an authorization loop is initiated S468. The authorization loop determines if the amount to be charged is higher than a predefined amount determined either by the user, or by a provider. If the amount is larger than the threshold, then an authorization request is submitted S471 to the user at the mobile device used to initiate the transaction. The authorization request requires a positive response for the transaction to proceed. If the request receives a negative response or no response at all at S472, then the transaction is canceled at S473. This provides additional security against unauthorized large transactions. If, however, the request returns a positive response from the user, then the transaction is authorized S469. The user account is debited S470, and the transaction is complete. Conversely, at step S468, if the amount is lower than a predefined threshold amount, then the transaction is automatically authorized S469 without requiring an authorization for the user, and the transaction is fulfilled S470.

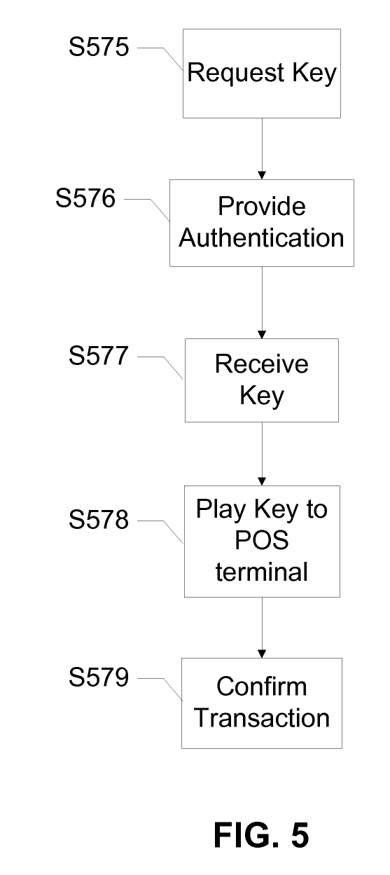

FIG. 5 shows a method for making mobile payments at a mobile device, according to an exemplary embodiment of the present invention. From the perspective of a user of the mobile device, the method starts with a request for a payment key S575 submitted at the mobile device to a server on the network. For instance, the user dials into the server, navigates a menu tree using DTMF tones or voice commands, and requests a payment key. The user has to provide an authentication S576 using one or more of several methods, including a username/password combination, a biometric identifier such as voice recognition, etc. The voice recognition can prompt the user to speak a random string of words every time, to prevent fraudulent transactions by unauthorized users who have recorded the user's voice. A name/password is spoken and recognized by an IVR system, or typed in using a keypad on the mobile device. Upon a successful authentication, a payment key is received S577 at the mobile device. The payment key is a unique string of alphanumeric or similar characters, and can be represented by a plurality (or sequence) of DTMF tones. The payment key is valid for only a short period of time sufficient to complete a transaction at a POS terminal. If a transaction is unsuccessful, a user can request an alternate payment key, at which point the previous payment key is rendered invalid.

The payment key is received at the mobile device S577 via a plurality of DTMF tones that are played over a speaker of the mobile device. Notably, the mobile device never stores the payment key—the playback of the DTMF tones on the speaker occurs in real-time as the DTMF tones are transmitted from the server. The mobile device simply acts as a conduit for the playback of the DTMF tones from the server to the microphone at the POS terminal. The user plays the DTMF tones to the POS terminal S578 by holding the speaker of the mobile device against a microphone of the POS terminal. The POS terminal submits to the server a bill including the payment key and an amount to be charged to the user for the purchase, etc. that the user has made. Upon a successful transaction, a confirmation message S579 is received by the user, notifying the user that the user's account has been debited by the amount to be charged.

Alternatively, an authorization loop can be invoked to determine if the amount to be charged is higher than a predefined amount. If the amount is larger than the threshold, then an authorization request is received at the mobile device. The authorization request requires a positive response for the transaction to proceed. The user can ignore the request or return a negative response to cancel the transaction, or return a positive response to authorize the transaction.

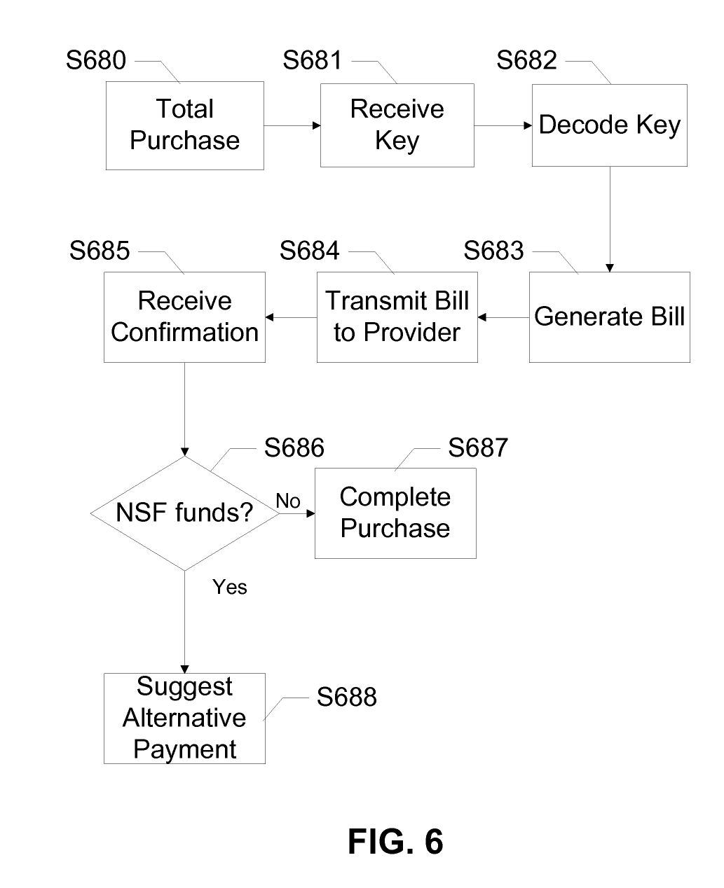

FIG. 6 shows a method for processing mobile payments at a POS terminal, according to an exemplary embodiment of the present invention. The method begins at the POS terminal with total amount being generated S680 for the user's purchase. When the purchase is ready to be processed, a payment key is received S681 from a mobile device via a plurality of DTMF tones that are played over a speaker of the mobile device. The mobile device is acting as a conduit for the playback of the DTMF tones from the server to a microphone at the POS terminal. The POS terminal includes a DTMF decoding logic that extracts S682 the payment key from the received DTMF signals. The decoding logic may be on a decoder chip coupled to the POS terminal, or via a decoding logic stored on a memory on the POS terminal. The POS terminal generates a bill S683 including the payment key and the total amount to be charged to the user for the purchase. The bill can further include other information such as a description of the purchase, instructions, notes, etc. The bill is transmitted S684 to a server on the network. The transmission can occur via the internet or via a phone connection, such as PSTN or cellular network. If the server determines that the key is valid, a confirmation message is returned to the POS terminal S685. Further, an insufficient funds loop S686 is initiated if the confirmation message returned at step S685 shows that the user has insufficient funds. If there are sufficient funds, the purchase is completed S687. If, however, there are insufficient funds in a user account, then the amount available may be charged, and a second bill is presented to the user to provide an alternative payment method S688.

Alternatively, the POS terminal includes an indicator to show whether or not a payment key is successfully extracted from the received DTMF signals. This indicator can be in the form of an LED light that shines, for instance, green if a payment key is successfully received and red if the payment key is incomplete. Payment keys can be checked via internal consistency checks such a cyclical redundancy checks (CRC). The user would request another payment key, thereby voiding the first key, and plays back a new payment key to the POS terminal.

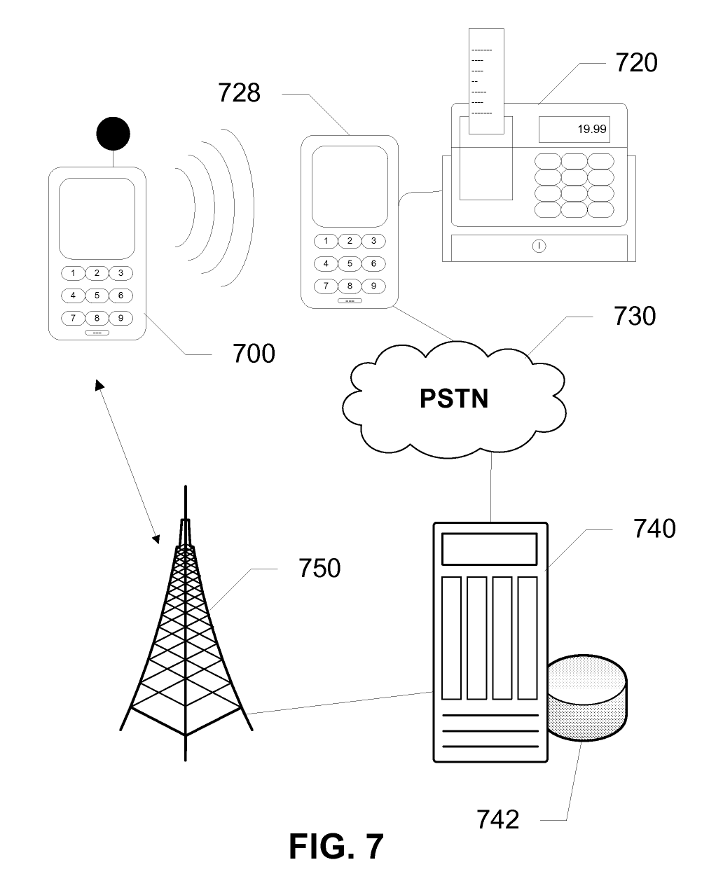

FIG. 7 shows a system for making mobile payments, according to an exemplary embodiment of the present invention. According to this embodiment, the system includes a mobile device 700, a point of sale (POS) terminal 720, and a server 740. Mobile device 700 interacts with POS terminal 720 to make payments using DTMF tones. Mobile device 700 includes at least a speaker to play the DTMF tones to POS terminal 720 and a transceiver to communicate with server 740 through a base station 750. POS terminal 120 includes a telephone 728 to receive the DTMF tones from mobile device and transmit the DTMF tones to server 740 over a public switched telephone network (PSTN) 730. In this embodiment, the microphone and DTMF processing logic are accessed via telephone 728. In this case the telephone may include the DTMF processing or contact an IVR sever to perform the processing.

To make a mobile payment, a user of mobile device 700 requests a payment key from server 740. The request is initiated for instance by making a telephone call across the network to server 740, and interacting with an Interactive Voice Response (IVR) system on server 740. Server 740 authenticates the user of mobile device 700. Server 740 compares an authentication from the user with authentication information stored on an authentication database 742. The authentication information may be a username and password, a biometric of the user, etc. When authenticated, the user requests a payment key from server 740 by, for instance, pressing a key on a keypad of mobile device 700, or using a voice command. Server 740 generates a one-time payment key associated with the user and with mobile device 700 and transmits the one-time key to mobile device 700 in the form of a series of DTMF tones. The payment key is valid for a prescribed time period determined by a service provider or by the user. Mobile device 700 emits the DTMF tones via its speaker. When placed next to telephone 728, the DTMF tones are received by a microphone of telephone 728, and decoded by decoding logic on telephone 728. In conjunction with POS terminal 720, the payment key and a total amount are submitted to server 740 via telephone 728. As described above, server 740 receives the bill and extracts the payment key received with the bill to determine the user account that is to be charged. If the payment key is valid and if the user account on database 742 has sufficient funds, server 740 accepts the transaction, debits the account of the user, and transmits a purchase confirmation to POS terminal 720 via telephone 728.

Alternatively, telephone 728 can be a cellular device, or a VOIP phone. Correspondingly, network 730 can be a cellular network using base stations such as 750, or a packet-based network such as the internet. Femtocells, fixed-wireless terminals (FWT), etc. can be used for communication between POS terminal 720 and server 740.

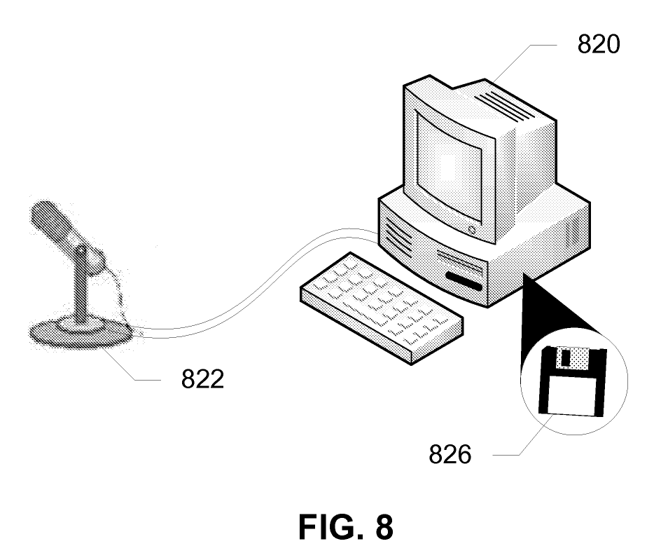

FIG. 8 shows a POS terminal 820 for accepting mobile payments, according to an exemplary embodiment of the present invention. In this embodiment, POS terminal 820 is a computer and includes a microphone 822 and DTMF logic 826 stored on a memory of POS terminal 820. When a user desires to make a payment to POS terminal 820, the user requests a payment key from a server using a mobile device. The server transmits the payment key to the mobile device encrypted into DTMF tones. The user places the speaker of the mobile device near microphone 822 such that microphone 822 receives the DTMF tones. Microphone 822 communicates the DTMF tones to POS terminal 820, such as through a USB cable. DTMF logic 826 decodes the DTMF tones to determine the payment key. POS terminal 820 generates a bill including the payment key and transaction details including an amount. POS terminal 820 transmits the bill to the server. If the server accepts the payment, POS terminal is notified that the transaction is complete. The server may alternatively request a separate payment form.

In alternate embodiments, money can be transferred between two individuals using their mobile devices or telephones. For instance, a mobile device can communicate the DTMF tones from the server to another user's mobile device or telephone. The paying user authenticates himself/herself/themselves as described above, and can indicate a specific amount to be transmitted via a unique DTMF sequence. The other user's phone “listens” to the DTMF sequence, either processes it onboard or transmits the DTMF signals to a server, and receives a confirmation from the server that a payment has been made. This enables phone-to-phone payments.

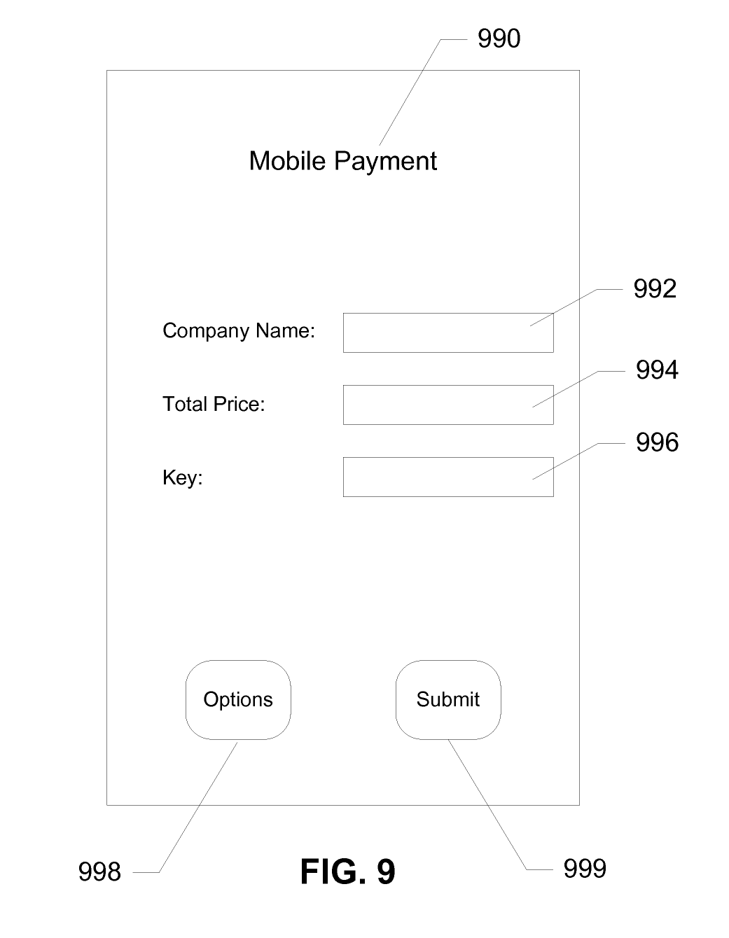

FIG. 9 shows an interface 990 for receiving mobile payments, according to an exemplary embodiment of the present invention. In this embodiment, a POS terminal uses interface 990 to accept a payment key in the form of DTMF tones from a mobile device. Interface 990 includes a company name field 992, a total price field 994, a payment key field 996, an options button 998, and a submit button 999. Company name field 992 provides a location for the seller to input a name for their company. Company name field 992 may be automatically filled if the POS terminal is only used for one company. Total price field 994 provides a location for the seller to input the total amount of a purchase by the user. Payment key field 996 is automatically filled by a DTMF logic when the POS terminal receives the payment key in the form of DTMF tones and the DTMF logic decodes the DTMF tones. The contents of company name field 992, total price field 994, and payment key field 996 are combined to create a bill for the transaction. Submit button 999 allows the seller to submit the bill to a server. Options button 998 provides the seller with further options for the transaction.

As will be understood by those having ordinary skill in the art upon reading this disclosure, the present invention can be incorporated in several settings, and modifications can be implemented to facilitate such incorporation. For instance, DTMF scanners can be coupled to turnstiles for mass public transit systems such as subways. A user would dial into a server, authenticate themselves, and play back a DTMF payment key into a microphone coupled to a subway turnstile. Upon successful billing, the user would be allowed through the turnstile. In this embodiment, the authorization loop described above need not be used. Instead, a maximum amount can be set for the transaction depending on the regular cost of using the mass public transit system. For more secure applications on capable devices, additional layers of biometric identifiers can be used such as fingerprint scanning, finger capillary patterns, etc.

Further, although the present invention enables the simplest mobile devices to perform mobile payments, a slightly more advanced device includes an application on a user interface enabling a user to program different types and amounts of payment for different applications. For instance, a subway turnstile payment can be selected by a user on a menu on said application. For a more complex payment such as at a grocery store, a separate menu option allows the user to enable an authorization loop. Further, banking applications can allow a user to withdraw and/or extract money from an automated teller machine, or provide their identity to a bank teller, simply by using the DTMF tones acquired from the server on the network. In alternate embodiments, the payment key is a credit card number, bank account number, or equivalent, and therefore does not expire after a one-time use or a predetermined time period. Several other applications and configurations are possible.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for making a payment using a mobile device, the system comprising:
a mobile device including a speaker, an input, and a transceiver for communicating across a network;
a point-of-sale (POS) terminal including a microphone for receiving a payment key from the speaker of the mobile device and a transceiver for communicating across the network; and
a server on the network including authentication logic for authenticating a user of the mobile device, key generation logic for generating the payment key in response to a request from the mobile device, and charging logic for charging a user account upon receipt of a bill from the POS terminal, the bill including the payment key received by the microphone and an amount to be charged to the user account,
wherein the payment key comprises dual-tone multi-frequency (DTMF) signals transmitted from the server to the POS terminal via the speaker on the mobile device.

2. The system of claim 1, further comprising an authentication database, wherein the authentication logic authenticates the user by comparing a unique identifier of the user with the authentication database.

3. The system of claim 2, wherein the unique identifier is one or more of a username, a password, and a biometric identifier.

4. The system of claim 3, wherein the biometric identifier is a voice sample.

5. The system of claim 1, further comprising a DTMF scanner coupled to the POS terminal, the DTMF scanner including the microphone and a DTMF processing logic.

6. The system of claim 1, further comprising a telephone coupled to the POS terminal, wherein the microphone and transceiver are coupled to the telephone, the POS terminal transmitting the bill to the server via a public switched telephone network.

7. The system of claim 1, wherein the authentication logic verifies that the payment key in the bill is valid.

8. The system of claim 7, wherein the payment key is invalid upon expiration of a time period.

9. The system of claim 1, further comprising an authorization logic on the server, the authorization logic transmitting an authorization request to the mobile device to confirm an amount larger than a predetermined amount.

10. The system of claim 1, further comprising a billing server in communication with the server, the charging logic charging the user account by transmitting a billing request to the billing server.

11. A method for making a payment using a mobile device, the method comprising:
receiving a key request from a mobile device;
authenticating a user of the mobile device;
generating a payment key;
transmitting the payment key to the mobile device using dual-tone multi-frequency signals;
receiving from a point-of-sale (POS) terminal a bill, the bill including the payment key and an amount to be charged;
determining that the received key is valid; and
debiting the amount to be charged from a user account associated with the user.

12. The method of claim 11, wherein authenticating the user further comprises comparing a unique identifier received from the mobile device with an authentication database.

13. The method of claim 12, wherein the unique identifier is one or more of a username, a password, and a biometric identifier.

14. The method of claim 11, further comprising verifying that the amount to be charged does not exceed a predetermined amount, said verifying further comprising: transmitting an authorization request to the mobile device; and receiving an authorization from the mobile device.

15. The method of claim 11, further comprising invalidating the payment key after a time period.

16. A method for charging a user at a point-of-sale (POS) terminal, the method comprising:
receiving a plurality of dual-tone multi-frequency (DTMF) signals from a speaker on a mobile device;
extracting a payment key from the DTMF signals;
generating a bill including the payment key and an amount to be charged;
transmitting the bill to a server across a network; and
receiving a confirmation from the network that the user is billed.

17. The method of claim 16, wherein transmitting the bill to the server occurs via a packet-switched network.

18. The method of claim 16, wherein receiving the plurality of DTMF tones occurs via a microphone coupled to a telephone, and wherein transmitting the bill further occurs via a public switched telephone network (PSTN).

19. The method of claim 16, further comprising: receiving an insufficient funds notification from the server.

20. The method of claim 19, further comprising: suggesting an alternative payment method to the user.
